(19) United States
(12) Patent Application Publication
(10) Pub. No.: US 2011/0187747 A1
(43) Pub. Date: Aug. 4, 2011

(54) METHOD OF DECODING ON AN ELECTRONIC DEVICE

(75) Inventors: Lawrence David McCarthy, Victoria (AU); Matthew John Ballard, Victoria (AU)

(73) Assignee: Commonwealth Scientific and Industrial Research Organisation, Australian Capital Territory (AU)

(21) Appl. No.: 12/999,399

(22) PCT Filed: Jun. 18, 2009
(86) PCT No.: PCT/AU2009/000789

§ 371 Date: Apr. 14, 2011

(30) Foreign Application Priority Data
Jun. 18, 2008 (AU) 2008903107

(51) Int. Cl. G09G 5/00; G06K 15/02

(52) U.S. Cl. 345/634; 358/3.28

(57) ABSTRACT

A hidden image method comprising: obtaining a first image and a second image, the first and second images providing between them a hidden image and a decoder such that a hidden image is decoded by the decoder when the first image and the second image are superposed at least one decoding position; printing the first image onto a light transmissive substrate to produce a printed substrate; displaying the second image on an electronic display; and superposing the printed substrate relative to the display at a decoding position to decode the hidden image.

### FIELD

The present invention relates to a hidden image method and a hidden image apparatus of particular, but not exclusive, application in the security field.

### BACKGROUND

Current decoders are small thin articles such rigid screens, masks which are overlaid on top of the article that contains the hidden image. Commonly lenticular lenses with ridges are used. The current decoders are manipulated or moved around so as to see the hidden image.

Manipulation is typically by way of horizontal or vertical alignment, or changing the viewing angle. Such decoders or lenses can be readily lost or physically damaged. They also often need additional light to actually reveal the image. Correct orientation is difficult as you have to line up, for example, a moving note with a moving mask on a flat surface. In security systems typically only a few decoders are issued to authorised users. Each decoder has to be made by hand or machine.

There is a need for an alternative hidden image decoding method.

### SUMMARY OF THE INVENTION

In a first aspect, the invention provides a hidden image method comprising:
obtaining a first image and a second image, the first and second images providing between them a hidden image and a decoder such that a hidden image is decoded by the decoder when the first image and the second image are superposed at least one decoding position;
printing the first image onto a light transmissive substrate to produce a printed substrate;
displaying the second image on an electronic display; and
superposing the printed substrate relative to the display at a decoding position to decode the hidden image.
In an embodiment, the decoder comprises a plurality of decoder lines.

In an embodiment, the method comprises configuring at least one of the first and second images such that the decoder lines are offset from the horizontal and vertical axes of the display to avoid visible moirés.

In an embodiment, the method comprises scaling the display of the second image based on a display format of the electronic display.

In an embodiment, the decoder is provided by one of the first and second images.

In an embodiment, the decoding is provided by the second image.

In an embodiment, the decoder is provided by both of the first and second images.

In an embodiment, each of the first and second images comprises a plurality of image elements arranged to form the hidden image and the decoder.

In an embodiment, the method comprises storing data representing the second image in a memory associated with the display.

In an embodiment, the method comprises generating the data representing the second image at a location remote from the memory and transmitting the data to the memory.

In an embodiment, the method comprises transmitting the data in response to a request from a processor operably associated with the memory.

In an embodiment, the method comprises providing a decoder identification with the printed substrate, receiving an input of the decoder identification via an input device associated with the processor and making the request in response to receipt of the decoder identification.

In an embodiment, the method comprises generating the data representing the second image with a processor associated with the memory based on at least one decoder algorithm.

In an embodiment, the method comprises providing a decoder identification with the printed substrate, receiving an input of the decoder identification via an input device associated with the processor and generating the second image with the processor based on the decoder identification.

In an embodiment, the method comprises controlling a time at which the decoder is transmitted.

In an embodiment, the method comprises controlling a time at which the decoder is generated.

In an embodiment, the method comprises spacing the first image from the surface of the display.

In an embodiment, the first and second images encode at least one additional hidden image.

In an embodiment, the first image encodes the at least one additional hidden image.

In an embodiment, the method comprises altering the display of the second image to decode the at least one additional hidden image.

In an embodiment, the method comprises moving the second image on the display.

In an embodiment, the method comprises replacing the display with a display of at least one further image which provides a decoder for the additional image.

In an embodiment, the method comprises selectively decoding portions of the first image by altering display of the second image.

In an embodiment, the method comprises sequentially decoding portion of the first image by altering display of the second image.

In an embodiment, the method comprises printing on the light transmissive substrate with an opaque ink.

In an embodiment, the ink is black.

In an embodiment, the ink is white or silver.

In an embodiment, the method comprises obtaining the hidden image and the decoder by generating them using a computerised security algorithm.

In a second aspect, the invention provides a hidden image method comprising:
obtaining a set of images, providing between them a plurality of hidden images and a plurality of decoders such that each hidden image is decoded by a corresponding decoder when at least two of the images are superposed at at least one decoding position;
printing at least one of the images onto a light transmissive substrate;
displaying at least one of the images on an electronic display; and
superposing the printed substrate relative to the display at a decoding position to decode the hidden image corresponding to the decoding position.

In a third aspect, the invention provides a hidden image apparatus comprising:
a printed substrate comprising a first image printed on a light transmissive substrate, the first image in conjunction with a second image providing a hidden image and a decoder such that a hidden image is decoded by the decoder when the first image and the second image are superposed at least one decoding position; and
a display device comprising an electronic display arranged to display the second image such that the printed substrate can be superposed relative to the display at a decoding position to decode the hidden image.

In an embodiment, the display device is arranged to scale the display of the second image based on a display format of the electronic display.

In an embodiment, the display device comprises an input device for receiving a user input, the display device configured to scale the display of the second image in response to the user input.

In an embodiment, the display device comprises a memory storing data representing the second image.

In an embodiment, the display device is arranged to receive data representing the second image transmitted from a location remote from the memory and store the data in the memory.

In an embodiment, the display device is arranged to transmit a request for data representing the second image.

In an embodiment, the display device comprises an input device and is arranged to receive an input of a decoder identification via the input device and make a request including the decoder identification in response to receipt of the decoder identification.

In an embodiment, the display device comprises a processor and a memory storing at least one decoder algorithm, the processor arranged to generate the second image based on the at least one decoder algorithm.

In an embodiment, the processor generates the second image in response to receipt of a decoder identification via the input device and uses the decoder identification to generate the second image.

In an embodiment, the display device is arranged to control a time at which the second image is generated.

In an embodiment, the display has a fixed number of pixels.

In an embodiment, the hidden image apparatus comprises a spacer for spacing the first image from the surface of the display.

In an embodiment, the hidden image apparatus comprises a printed substrate holder for holding the printed substrate at a decoding position relative to the display.

In an embodiment, the hidden image apparatus comprises a feeding mechanism for feeding printed substrates to the printed substrate holder.

In an embodiment, the hidden image apparatus comprises a removal mechanism for removing printed substrates from the printed substrate holder.

In an embodiment, the hidden image apparatus comprises an verification image capture device arranged to capture a verification image of the light transmissive substrate superposed on the display.

In an embodiment, the hidden image apparatus comprises a verification module arranged to determine from the verification image whether the hidden image has been decoded.

In an embodiment, at least a third image in combination with the first and second images provides a further hidden image which can be decoded by the decoder or a further decoder.

In an embodiment, the hidden image apparatus comprises a further printed substrate carrying the third image.

In a fourth aspect, the invention provides a display device for a hidden image apparatus comprising:
a memory storing data representing a second image of a first image and a second image, the first and second images providing between them a hidden image and a decoder such that a hidden image is decoded by the decoder when the first image and the second image are superposed at least one decoding position; and
an electronic display arranged to display the second image such that the first image can be superposed relative to the display at a decoding position to decode the hidden image.

In a fifth aspect, the invention provides computer program code which when executed implements the method of the first or second aspects.

In a sixth aspect, the invention provides a computer readable medium comprising the above computer program code.

In a seventh aspect, the invention provides a hidden image method comprising:
generating an image containing a hidden image based on a pixel size of at least one display intended to be used to decode the image;
printing the image on a light transmissive substrate to form a image substrate; and
overlaying the image substrate on a display compatible with the intended display so that the image substrate is decoded by the sub-pixels of the display to reveal the hidden image.

In an embodiment, generating an image based on a pixel size comprises setting the size of features encoding the hidden image based on the pixel size.

In an embodiment, the method comprises setting the separation of periodic elements in the hidden image to correspond to the pixel size.

In an embodiment, the method comprises encoding the hidden image as a Phasegram.

In an embodiment, the image encodes two different hidden images, viewable at different angles of the substrate relative to the display.

In an embodiment, the method comprises generating a first portion of the image based on the pixel size of a first display intended to be used to decode the first portion and generating a second portion of the image based on the pixel size of a second display intended to be used to decode the second portion.

In an embodiment, the pixel size of the intended display is derived from the actual pixel size of a plurality of displays.

In an embodiment, the method comprises printing the image in monochrome at least portions of the image to encode colour and intensity of colour.

In an embodiment, the method comprises dividing the hidden image into notional vertical pixel regions intended to overlay a colour of a one or more contiguous sub-pixels of the intended display and selectively controlling which portions of the notional sub-pixel are opaque to control the intensity of the colour.

In an embodiment, the method comprises printing opaque regions less than the width of a sub-pixel to control the intensity of a sub-pixel.

In an embodiment, the method comprises printing the image in black and white.

In an eighth aspect, the invention provides a hidden image substrate comprising a light transmissive substrate having printed thereon a hidden image based on a sub-pixel size of a display intended to be used to decode the hidden image.

### BRIEF DESCRIPTION OF THE DRAWINGS

Embodiments of the invention will now be described by way of example in connection with the following drawings, in which:

FIG. 1 is a flow chart of a method of an embodiment;

FIGS. 2A and 2B schematically show the decoding process;

FIGS. 3A and 3B are examples of overlaying a transparent display on a computer monitor and a mobile phone respectively;

FIG. 4 is a block diagram of an exemplary hidden image system;

FIG. 5 is a schematic diagram of an exemplary hidden image apparatus;

FIG. 6A shows an undecoded hidden image printed on a substrate;

FIGS. 6B and 6C show the hidden image of FIG. 6A decoded at two different angles by the sub-pixels of a display;

FIG. 7 shows detail of the decoded image of FIG. 6B;

FIG. 8 is a flow chart of a method of an embodiment;

FIG. 9 shows an example where two different images are encoded;

FIG. 10 is an example of a hidden image having portions tuned to two different display resolutions;

FIG. 11 is an example of an image sub-pixel decoded by a mobile phone screen;

FIG. 12 illustrates the sub-pixels that form a pixel;

FIGS. 13 to 16 illustrate how a black and white image can encode colour information decoded by a display;

FIG. 17 illustrates how colour information is hidden in the black and white image;

FIG. 18 illustrates a further technique for encoding colour information; and

FIG. 19 is an example of images encoding colour information.

### DETAILED DESCRIPTION

### Overview

A hidden image (or “latent image”) is arranged such that when overlaid on an appropriate decoder details of the image which were previously concealed are revealed. That is, the hidden image is transformed by the decoder such that it is revealed to the user or an image capture device. For example, the hidden image without the decoder may appear to be a pattern but once the decoder is overlaid an indicia is revealed. Put another way, the concealed image is security information which is revealed by the transformative effect of the decoder.

In one exemplary embodiment, the decoder is displayed on an electronic display. In another embodiment, the sub-pixels of the display are used to provide the decoder.

In an embodiment, a hidden image is produced on a computer using an appropriate technique, for example that described in CSIRO's PCT/AU2004/000915 (WO 2005/002880) and known as Phasegram technology. In an embodiment, a hidden image is printed on light transmissive substrate such as a transparent film, for example, using a gravure printing process with opaque ink. A corresponding image containing the decoder is displayed on an electronic display device under control of a computer program or other device for driving a display. (That is, both the latent image and the decoder are images.) In an advantageous embodiment the computer program scales the image size to suit the display monitor device. In one embodiment, the image on the light transmissive substrate is held up to the monitor to decode (reveal) the hidden image(s) when in correct superposition. Thus, a hidden image apparatus is provided by a suitable display device for displaying the hidden image and a light transmissive substrate (or a plurality of light transmissive substrates).

With some encoding techniques, such as Phasegram, it is possible to reverse the roles of the decoder and the hidden image—i.e. so that the hidden image is rendered on the display and the decoder is printed on the substrate. Some encoding techniques, such as Phasegram, also allow portions of the hidden image to be exchanged with corresponding portions of the decoder image so that the hidden and decoder images are provided in combination by two images.

Some encoding techniques, such as Phasegram, also allow multiple decoders and/or multiple images to be hidden in a single image. Similarly, they may allow a combination of decoders and hidden images to be in a single image. This allows, for example: multiple hidden images to be hidden in one image so that they can be revealed concurrently or at different relative angles of the images; and multiple hidden images to be revealed sequentially using different decoders.

Thus, embodiments of the invention advantageously employ a display to provide the decoder. Depending on the embodiment, various obstacles have to be overcome to implement a decoder (or latent image) on a display as described in further detail below.

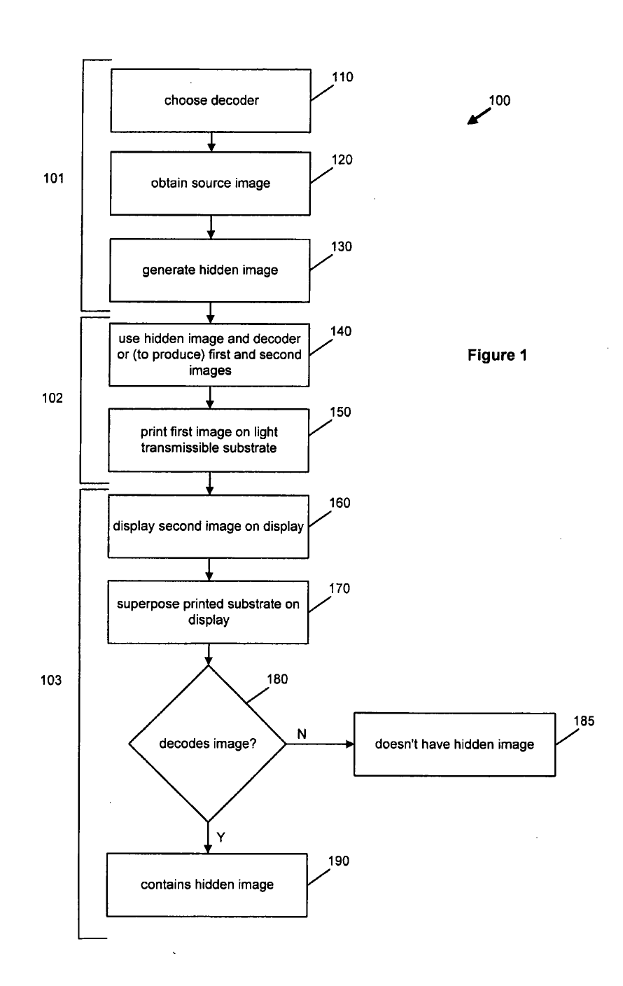

The method of an embodiment 100 is summarised in FIG. 1 and involves a first stage 101 of generating a hidden image. This stage 101 involves choosing a decoder 110, obtaining a source image 120 to form the image that will be hidden within the hidden image, and generating 130 a hidden image in accordance with one of the suitable transformative techniques described in further detail below. It will be appreciated that when decoded, the hidden image will reveal an image closely related to the source image. The image hidden within the hidden image is, in effect, security information, which is used to for verification or authentication. Such that the state of an article of manufacture to which the hidden image is applied can be changed from unauthenticated to authenticated by applying the relevant decoder.

The second stage 102 involves taking the hidden image and decoder, and, if necessary, using them to form the first and second images 140. This step 140 is optional and is implemented where the first and second images are not also the hidden and decoder images, for example in a case where corresponding portions of the hidden image and the decoder image are exchanged. The method then involves printing 150 the first image on a suitable light transmissive substrate such as a film. The film may form, for example, part of a bank note or other security document as described in further detail below such that in a typical application the document or instrument carrying the first image can be distributed for checking at a later date.

The third stage 103 is a checking stage. The printed first image is presented to the person checking the document. The person places the first image at the relevant position of the display and causes the display to display 160 the second image (if it is not already displayed). That is, the person superposes the printed substrate on the display 170. It is then determined 180 whether this decodes the image. If the hidden image cannot be viewed the printed substrate does not include the hidden image 185. If the hidden image can be perceived or captured by an image capture device, it does contain a hidden image 190 and thus, the printed substrate, whether part of an article of manufacture or attached to an article, can be authenticated to thereby authenticate the article.

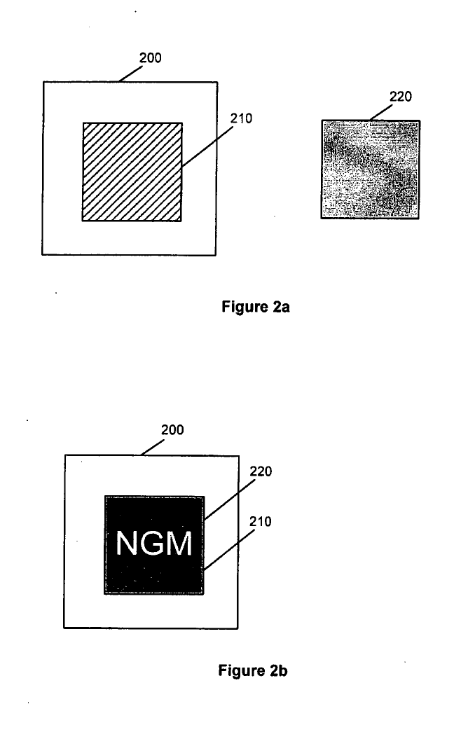

FIG. 2 shows schematically how an image can be decoded. In FIG. 2a, a computer monitor 200 is used to display a decoder having a plurality of decoding lines (in this example, the decoding lines are diagonal). A latent image on a transparent substrate 220 cannot be perceived. In FIG. 2b the substrate 220 has been superposed on the decoder 210 on the display 200 and the initials “NGM” can be perceived on the display.

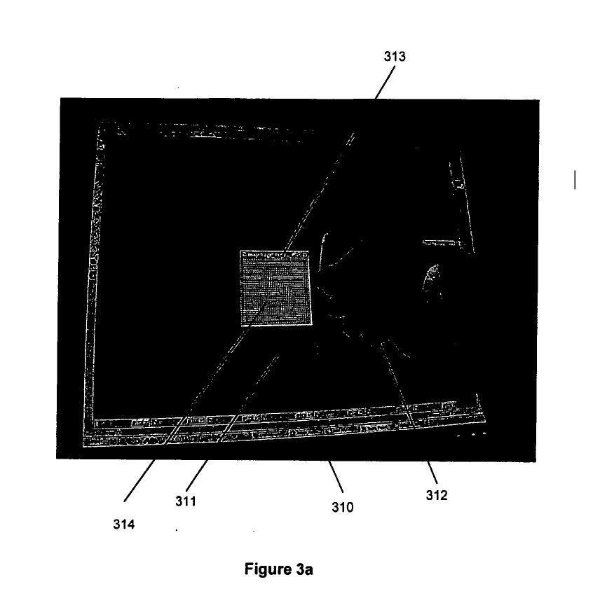

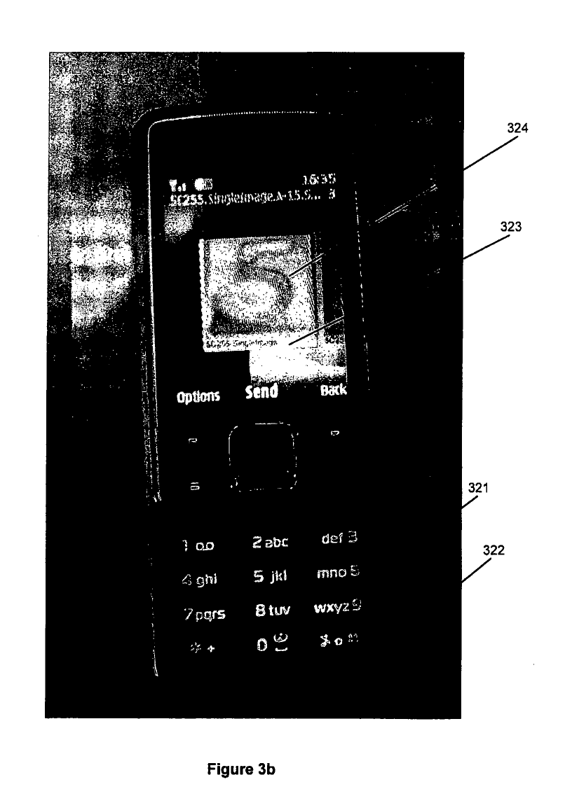

FIGS. 3a and 3b are photographs of an actual implementation. FIG. 3a shows a persons hand 312 holding a transparent substrate (which it will be noted as bigger than the window 313 containing the decoder) relative to display 310. A number “5” 314 can be perceived. FIG. 3b shows a similar implementation where a transparent film 322 having a plurality of images printed thereon is overlaid so that one of the images 323 overlays a decoder output on the display of a mobile phone 321. Again, a number “5” 324 can be perceived.

### Hidden/Latent Image Techniques

One embodiment relates to latent images that implement line decoders on a display. (Line decoders are also known as line screens or masks.) Existing line decoders are typically formed of a plurality of parallel dark and transparent (light transmissive) lines as the decoders are designed to overlay a latent image formed of dark and white image elements. However, in some techniques the roles may be reversed, by overlaying a latent image that includes transparent portions on a decoder as described in further detail in WO 2005/002880.

In the embodiment, the display is controlled to display white and dark portions and a light transmissive substrate has dark and transparent portions encoding the latent image. However, in some techniques the roles may be reversed, by overlaying a latent image that includes transparent portions on a decoder as described above. Further some latent image techniques can be implemented in colour, in such techniques the colour portions are the “dark” portions”.

It will be understood that when describing how latent image techniques can be implemented, the term “white” can include “transparent” unless the context implies otherwise. That is, if an element is white when used on the display, it can be transparent on the substrate and vice versa.

Examples of processes for producing a latent image that is suitable for use are the processes for producing a Phasegram described in WO 2005/002880.

In Phasegram, multiple images, such as photographic portraits, are digitized and then separated into their various grey-scales or colour hue saturations. Line screens with various displacements are then overlaid in the black areas of each of these separations, with the line screens displaced according to the grey scale or hue saturation of the separation. The adjusted images are then combined to create a new image. All of this is done in a digital process by a computer algorithm. The use of a digital computer method allows for variations in the construction and final presentation of the hidden image that are not possible using a comparable analogue (photographic) process. The new images are extremely complex, defying human observation of the hidden image(s) even at full magnification.

Binagram (PCT/AU2004/000746) is similar in concept to Phasegram, involving using a computer algorithm to generate a new printing screen. In this case however, the fundamental principle used is not that of displaced line screens, but rather the principle of compensation in which each element of the hidden image is paired with a new element of complementary density.

Other techniques developed by CSIRO known as TCM (PCT/AU2006/001867) and Anigram (PCT/AU2003/001331) can also be employed.

Persons skilled in the art will appreciate that other latent image techniques can be used. The particular suitability of such techniques will vary depending on what effects are desired to be achieved and there compatibility with the hidden image techniques described below. Persons skilled in the art can readily ascertain their suitability.

One example, “Scrambled Indicia”, are described in analogue form in U.S. Pat. No. 3,937,565 and in a computerized, digital version in Patent WO 97/20298. In the latter technique, the computer program effectively slices the image to be hidden into parallel slivers called “input slices”. These are then scrambled, generating a series of thinner “output slices” that are incorporated into an image in a form that is incoherent to the human eye. When viewed through a special device containing many microscopically small lenses, the original image is, however, reconstituted, thereby rendering the hidden image visible.

Scrambled images of this type may be incorporated into a visible background picture by matching the grey-scale or colour saturation of the hidden image to the background picture. This is achieved by adjusting the thickness of the features in the scrambled images to suit.

Latent images may also be formed by “modulation” of the line- or dot patterns used to print images. In order to print an image, professional printers use a variety of so-called “screening” techniques. Some of these include round-, stochastic-, line-, and elliptical-screens. Examples of these screens are shown in U.S. Pat. No. 6,104,812. Essentially, the picture is broken up into a series of image elements, which are typically dots or lines of various shapes and combinations. These dots and lines are usually extremely small, being much smaller than the human eye can perceive. Thus, images printed using such screens appear to the eye to have a continuous tone or density.

Hidden images can be created by juxtapositioning two apparently similar lines with one another. Processes in which an image is hidden by changing the position, shape, or orientation of the line elements used in printing screens are formally known as “line modulation”. The theory of line (and dot) modulation is described by Amidror (Issac Amidror, “The Theory of the Moiré Phenomenon”, Kluwer Academic Publishers, Dordrecht, 2000, pages 185-187). When two locally periodic structures of identical periodicity are superimposed upon each other, the microstructure of the resulting image may be altered (without generation of a formal Moiré pattern) in areas where the two periodic structures display an angle difference of α=0°. The extent of the alteration in the microstructure can be used to generate latent images which are clearly visible to an observer only when the locally periodic structures are cooperatively superimposed. Thus, the latent images can only be observed when they are superimposed upon a corresponding, non-modulated structure. Accordingly, a modulated image can be incorporated in an original document and a decoding screen corresponding to the non-modulated structure used to check that the document is an original—e.g. by overlaying a modulated image with a non-modulated decoding screen to reveal the latent image.

Examples of concealing latent images using line modulations are described in various patents, including the following: U.S. Pat. No. 6,104,812, U.S. Pat. No. 5,374,976, CA 1,066,109, CA 1,172,282, WO03/013870-A2, U.S. Pat. No. 4,143,967, WO91/11331, and WO2004/110773 A1. One such technique, known as Screen Angle Modulation, “SAM”, or its micro-equivalent, “μ-SAM”, is described in detail in U.S. Pat. No. 5,374,976 and by Sybrand Spannenberg in Chapter 8 of the book “Optical Document Security, Second Edition” (Editor: Rudolph L. van Renesse, Artech House, London, 1998, pages 169-199), both incorporated herein by reference. In this technique, latent images are created within a pattern of periodically arranged, miniature short-line segments by modulating their angles relative to each other, either continuously or in a clipped fashion. While the pattern appears as a uniformly intermediate colour or grey-scale when viewed macroscopically, a latent image is observed when it is overlaid with an identical, non-modulated pattern on a transparent substrate.

Examples of concealing latent images using dot modulations are described in various patents, including WO02/23461-A1.

Regarding printing of the device the usual requirements for hidden image work apply: high contrast, good ink opacity, low ink migration. Print resolution should be significantly higher than the monitor resolution.

Such devices will be particularly successful where contrast is high; with such devices the contrast is provided between light transmissive film and opaque ink.

Further security enhancements suitable for printing may include using colour inks which are only available to the producers of genuine bank notes or other security documents, the use of fluorescent inks, or embedding the images within patterned grids or shapes.

### Implementing a Display Based Decoder

Embodiments can be implemented on a variety of different display types. Many currently deployed displays (and most new displays) are of the addressable type—i.e. having a fixed number of display elements (pixels), for example a LCD (liquid crystal display) or plasma display panel. In contrast to analogue display devices such as CRT (cathode-ray tube) computer monitors you can vary the pixels/inch of the display in an infinitely continuous way, current LCD monitors are fixed in their pixel position and thus are more limited in the number of pixels per inch they can depict. For example a typical LCD is 1280×1024 pixels but display resolutions vary and are changing overtime (in some cases pixels are not even symmetrically arrayed).

A wide variety of displays can be used including those of, mobile phones, personal digital assistants, fixed and portable entertainment systems, electronic games, instrument readouts, mp3 players, global positioning units, point of display tills, electronic tellers, electronic checkout systems etc.

In practice, a decoder will need to be deployed on displays of different resolution. We have determined that this poses a particular problem when attempting to display decoders and/or hidden images which need to be displayed with a high degree of accuracy as if the decoder is displayed at a resolution different to that in which it was produced, the scaling process will result in a degraded decoder which introduces unacceptable moirés. (Bearing in mind that the image should be of the same relative physical dimension as the printed substrate). This is because the display can effectively only turn an individual pixel on or off. So when for example, and image need is scaled down from say 5 pixels to 4 there, the process will introduce moirés.

The inventors have determined that one advantageous form of a decoder has angled lines (off horizontal or vertical) to allow the use of scaling to adjust the size of the displayed image to match the printed device without moirés and thus ensure decoding almost independently of the display that is used. That is, correctly angled lines do not produce moirés with the display pixel array regardless of line spacing. These angles are selected so that interference with the existing regular array of pixels is avoided.

Thus, the decoder image only has to be scaled to suit the intended display monitor; no resolution information about the monitor is required but this information can be used if it is available.

As described further below, in a typical implementation, ‘one time only’ scaling or calibration is carried out by the user physically measuring the width and height of a displayed decoder with a ruler and entering these measurements via a user interface into the software for storage. After scaling the software will display decoding screens and/or other security devices at the physical correct size and aspect ratio.

Any of the many rescaling algorithms known to the art can be utilised and a judicious amount of anti-aliasing aids decode performance.

Experimental work carried out to date indicates that a larger number of decoders can be implemented with a printed image in an opaque ink that also conceals the image. To date, combinations of good decoding and good concealment have been achieved with line angles (LA) in the range 15-75 degrees from vertical and line widths (LW) from 201 to 624 microns. Reducing the maximum phase shift of a Phasegram to about 50% improves concealment. Not every one of these combinations will provide a device that is both concealed and decodes well and the best combinations also vary with the ink colour used to print on the light transmissive substrate. An example of a successful decoder for a hidden image printed with black ink on film is a LA of 35 degrees and LW of 413 micron. An example of a successful decoder for a hidden image printed with white ink on film is a LA of 30 degrees and LW of 519 micron. Both examples employ a reduced phase shift of 50% maximum to improve concealment of the Phasegram. Other inks of suitable opacity can be employed, for example, silver ink.

The LA can be chosen by the use of suitable angles to avoid visible moirés with any fixed arrays of pixels.

Other angles which work for black ink include 15, 20, 35, 40, 55, 60, whereas for white ink the full range from 15-75 degrees in 5 degree intervals can be made to work.

In some embodiments, the hidden image can be decoded while spaced from the surface of the display. In embodiments where it is intended that a person observe the hidden image, the spacing that is used depends on how the viewer's eyes can be expected to handle depth of field. In some applications, it may be appropriate to provide a lens system that has the needed depth of field.

Effects Achievable with Display Based Decoder

Employing a display based decoder allows a number of effects to be achieved, for example animation in the decoded image. This can be achieved by moving the decoder on the display relative to the hidden image or in some instances by changing the decoder. This provides as well as an added degree of novelty an increased amount of security because of the stronger relationship of the printed image to that displayed on the monitor. It is also possible, for example, to provide embodiments where information is provided by sequentially or selectively decoding sections of the printed image in a particular order to provide a code.

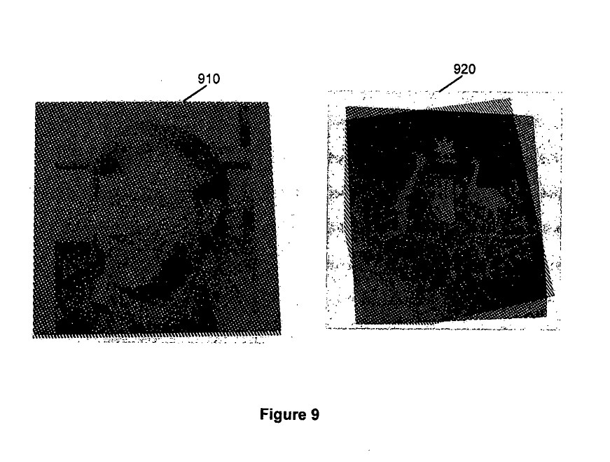

Another way to achieve an effect is by changing the line angle of the decoder on the display monitor. For example an animation can be achieved by producing a hidden image in the form of a two image Phasegram using the same line width but different line angles. Similar effects can be achieved by varying the line width of the decoder. Further an image can be produced which encodes a plurality of images at different line angles. A two image example is shown in FIG. 9 which illustrates a face latent image 910 decoded at a first angle and a coat of arms image 920 decoded at a second angle.

### Generating a Hidden Image to be Decoded by Sub-Pixels

In the above embodiment, a decoder is chosen or generated which decodes the hidden image. In this embodiment the hidden image is printed on a light transmissive substrate and sub-pixels of the display are used to provide the decoder. That is, some displays, such as LCDs and plasma displays, have a plurality of sub-pixels which are controlled to produce the desired colour of each pixel. For example, a typical LCD pixel has red, green and blue sub-pixels which can be mixed to form desired colours (black is generally formed by turning a pixel off). Cathode ray tubes use a similar technique involving multiple light sources of different colours. The embodiment employs screen colours where all the sub-pixels are on, for example when displaying white.

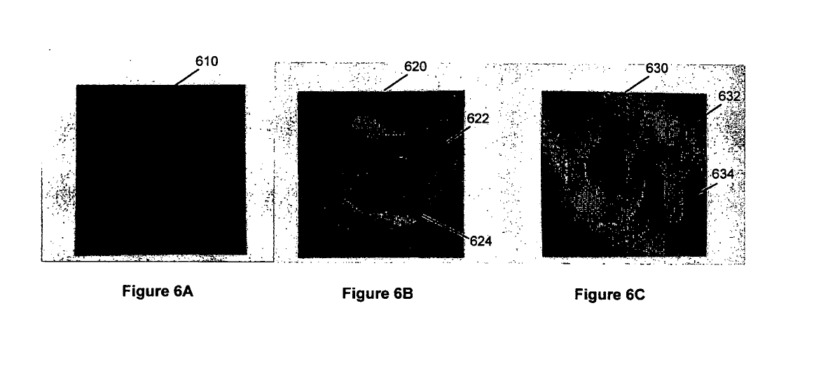

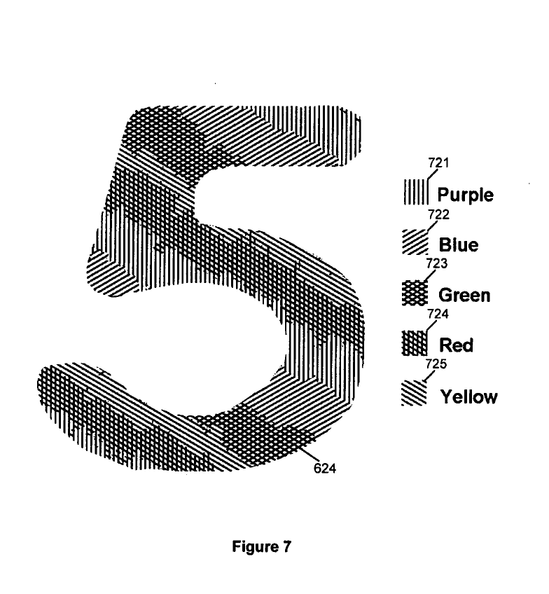

One exemplary hidden image was printed on a sheet of clear transparent plastic using black ink to form the hidden image substrate 620 shown in FIG. 6A. The image hidden in substrate 610 is imperceptible once printed. The hidden image 610 was encoded using the Phasegram technique described above and by selecting line widths/number of gray shades. When the hidden image substrate was held very close to or directly on a display monitor (LCD or CRT) at the correct angle, a coloured, extremely vivid, hologram-like image of the number five 624 appears in the hidden image substrate 620 as illustrated in FIG. 6B and FIG. 7. FIG. 6B shows the actual display in a black and white reproduction of a colour image (the display actually being in colour), from FIG. 6B, it will be appreciated that there is some variation in colour in the background 622 but significant variation in colour in the number five 624 of the hidden image 620. An approximate colour break up of the number five 624 is illustrated in FIG. 7 where legend 721-725 corresponds to the colours purple 721, blue 722, green 723, red 724, and yellow 725. The reverse effect is achieved when the substrate 630 is rotated 90 degrees as illustrated in FIG. 6C which shows a substantially grey five 634 on a coloured background 632. In this case, a rainbow of additional colours is produced which were not in the black and white (clear) Phasegram but in general, this technique results in at least one additional colour becoming visible to the viewer. It should be noted that the actual colours which are perceived vary with viewing angle and the accuracy of the match to the pixel size of the monitor. In some embodiments, a strong rainbow of colours may be produced in the background (or exterior portion of the image), but these are out of phase with the colours of the “5” (or interior portion of the image) or repeat with a different period.

The image can be printed at an appropriate line width to be decoded by sub-pixels because in general terms printer technology allows a higher degree of resolution than display technology. In WO 2005/002880 it is explained that while it is generally desirable to print with the highest resolution possible, it is also possible that individual image elements of a Phasegram may be formed of a plurality of pixels. This can be used in this embodiment to match the printing size to the screen's sub-pixel display size.

That is, the hidden image is decoded by the sub-pixels of the display acting as a decoding screen, and in addition takes on the colours of these underlying sub-pixels. To achieve the most advantageous effect, a hidden image must be tuned to a specific pixel size in order to decode perfectly—so a hidden image designed to decode perfectly on a 17″ monitor will in general not decode perfectly on a 19″ monitor because their resolution in dots per inch (dpi), and hence pixel size, are different. This is a limitation, but it is possible to design the hidden image so that it decodes “good enough” on both monitors, for example by using an average dpi of the two monitors.

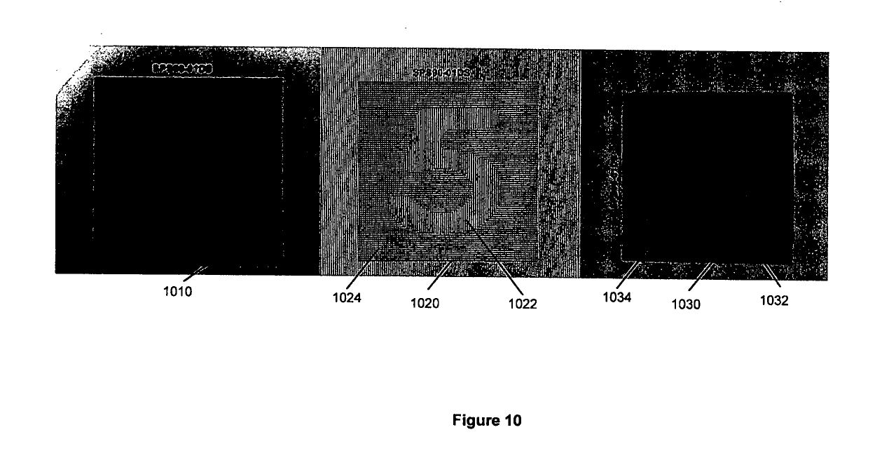

Accordingly, the embodiment can be advantageously applied with displays of a particular sub-pixel size. In one embodiment, a display can be employed which has an unusual pixel size to reduce the chance of accidental decoding. Further, in this context, it is to be understood that the display need not actually be able to display images, rather the display need only output light—i.e. such that the sub-pixels are active. In addition, it is possible to incorporate plural hidden images suited for different resolutions in a single image. One way the inventors have achieved this is by tuning an interior portion of the image to a first dpi and an exterior portion of the image to a second dpi as described in further detail below. A further way in which it is possible to achieve this is to include a series of images tuned to different resolutions next to one another. An example of such an image is shown in FIG. 10. The original undecoded image 1010 is tuned to two different resolutions. It decodes on displays 1020 having 96 dpi (or similar) such that the portions 1022 within the boundaries of the character 5 decode and on displays 1030 having 129 dpi such that the portions 1034 outside the boundaries of the character 5 decode. Two images which are overlapping can be tuned to different resolutions in a similar manner (although the differences are not as distinct).

A normal Phasegram screen as described in WO 2005/002880 is an alternating pattern of black and white (clear) lines (for a black and white Phasegram). A Phasegram device can then be designed that modulates the phase of a pixel depending on its gray scale intensity. The period of the screen creates features in the encoded device separated by the same period. It is possible to produce Phasegrams where these features are angled, and the period is a fractional number of pixels wide as described in further detail below.

In this respect, in the above embodiment which employs a displayed decoder, the periodic features, or the line frequency of the Phasegram must be the compatible the line frequency of the displayed decoder. An equivalent statement is that the wavelength of the Phasegram must be the same as the decoder.

Consider a Phasegram with 7 shades. A conventional Phasegram is formed with a decoding screen that has lines 6 pixels wide: 6 black, then 6 white, 6 black, 6 white, and so on. If this is rendered at 100 dpi (dot per inch), then each line would be 6/100 inches wide, the wavelength would be (6+6)/100 inches= 12/100 inches, and the frequency would be 100 dots per inch/(6+6 dots per line)=100/12 lines per inch. So the Phasegram device is printed so that it has a wavelength of 0.12 inches, no matter what the printing resolution. Equally well, it is possible to decide on a printed resolution and number of shades, then calculate the required wavelength in pixels for the display of the decoding screen on a particular monitor, then construct that. However, there is a practical lower limit of resolution: lines less than about 1 display pixel wide (wavelength=2 pixels) are rendered poorly, and screens constructed of such fine lines do not work well.

In this embodiment, instead of a pattern of alternating black and white lines, the sub-pixels are exploited to be the decoding screen as they define a pattern of alternating red, green and blue lines.

This limits practical Phasegrams to a fixed wavelength—i.e. it is necessary to match or “tune” the wavelength of the printed Phasegram to the wavelength of the sub-pixels—and the latter is exactly 1 display pixel. Since there is one white line and one black line per wavelength in a Phasegram, this means that the black lines of the Phasegram are 0.5 display pixels wide. In terms of equations, define the following terms:
DPIₘ is the “dots per inch” resolution of the display monitor
DPIₚ is the “dots per inch” resolution of the printer
Lambda is the wavelength, in inches
PLW is the Phasegram Line Width, in inches
PP is the Phasegram line width, in printer pixels
N is the number of shades of the Phasegram
   then:
Lambda=1/DPIₘ
PLW=Lambda/2=½×DPIₘ
PP=PLW×DPIₚ
N=PP+1

For example, if DPIₘ is 100 dpi, and DPI is 1200 dpi then:

### Lambda=0.01″

### PLW=0.01″/2=0.005″

PP=0.005″×1200 dpi=6 printer pixels
N=6+1=7 shades.

This does mean that perfect decoding will only occur on a display monitor that has pixel size (i.e.: dpi) that exactly matches that of the Phasegram. Fortunately, an inexact match, or various harmonics of the calculated line frequencies, will still produce strong colours in Moiré bands, so that provided the mis-match is not too great, the Phasegram can still decoded.

The inventors have determined that it is possible to provide lines of non-integer width by varying the number of pixels used for the lines of the screen used to encode the Phasegram or other line screen based encoding techniques. The line width is defined by an average of the number of pixels in the line screen. In this application, this allows the periodic elements in the Phasegram to be matched to the pixel separation

Normally the desired image size, line width and angle are defined prior to the preparation of the Phasegram so it is necessary to arrive at the required artwork by an algorithm. There are many ways this can be done, two examples:

### 1. Using a Commercial Artwork Rescaling Application or Algorithm:

An example will be used to demonstrate this method; let us say that an image 1000×1000 needs to be converted to a Phasegram of the same size, 1000×1000 pixels. The desired Phasegram array line width is 6.89 pixels and the line angle will be −33 degrees. This will be achieved by rescaling a preliminary Phasegram with lines 6 pixels wide to produce one with lines 6.89 pixels wide. The dimensions of the required preliminary Phasegram are:

1000×6/6.89=−870.827 pixels wide and high

This is not practical to do exactly; digital images are constrained to use integer numbers of pixels to define the width and height. Therefore ˜870.827 is rounded to 871, making the preliminary Phasegram 871×871, when it is rescaled back to 1000×1000 pixels the lines will become ˜6.888634 wide; for most work this may be an acceptable approximation.

A more accurate approach is to add a temporary border to the edges of the artwork to bring it to a dimension that can be divided exactly by 6.89: By multiplying 6.89 by 200 we get 1378; if a border 378 pixels wide is added to the right and bottom edges of the original artwork the preliminary Phasegram dimensions become:

(1000+378)×6/6.89=1200 pixels wide and high

After the border is added the starting image is rescaled to 1200×1200 pixels using an image processing application or any existing rescaling algorithm that produces good quality rescaling. This image is now processed to produce a Phasegram by the methods described in WO 2005/002880, by which the average width is related to the line angle by the formula L=H Cos(A). Thus, one way of achieving a non-integer line width is to select the line angle. In this case to achieve an average of 6.89, the line angle will be −33 degrees and the line width 6 pixels.

The Phasegram is then rescaled back to 1378×1378 pixels using an image processing application or existing rescaling algorithm that produces good quality rescaling, then the border is trimmed off producing a 1000×1000 pixel Phasegram. At this stage the Phasegram typically contains a range of greys as a result of an anti-aliasing and rescaling algorithm, so in one example, a standard colour reduction algorithm is used to reduce the shade range to black and white. This process replaces the grey pixels with either black or white pixels; the distribution of added black and white pixels provides an area average that simulates the original grey pixels. Overall the distribution of black and white pixels provides a screen having an average that simulates lines of the correct width, 6.89 pixels.

### 2. Implementation of a Direct Algorithm in Software:

In the literature several algorithms have been published that produce angled lines with an optimum distribution of the jagged steps. The optimisation is intended to provide the smoothest visual line possible. The best known of these is Bresenham's Line Algorithm. See for example,
http://en.wikipedia.org/wiki/Bresenham's line algorithm
http://www.research.ibm.com/journal/sj/041/ibmsjIVRIC.pdf

To execute the Bresenham algorithm in software all that has to be provided are the start and finish co-ordinates of the required single pixel lines. Moreover these co-ordinates are not constrained to integer numbers of pixels in a generalised software implementation of the Bresenham algorithm.

The decoding mask can be produced by drawing a grouped sequence of parallel single pixel lines running at the required angle A. The number of single pixel lines in each group and the spacing between each group is selected to provide the L pixel wide black and white lines of the decoder screen. Consider the co-ordinates of the ends of each single pixel line as a series of [X1, Y1] and [X2, Y2]. To completely fill the decoder screen with lines all of these co-ordinates must lie on the edges of the required screen. Because of the line angle A the co-ordinates [X1, Y1] are related to [X2, Y2] by:

(X2−X1)/(Y1−Y2)=Tan(A)

L, A and H are related by:

H=LSec(A)

Notice that H represents the change in the X co-ordinates to traverse the full width of a single decoder line (usually the same for white and black). There is no requirement for integer values for either H or L (or A for that matter) but the number of single pixel lines in each group must be an integer. Define the group size as G where G is the first integer greater than H.

To produce the full width black and white lines of the decoder the software will draw and count G black single pixel lines then skip G single pixel lines to produce the white. This sequence will be repeated to complete the decoder screen.

To ensure complete coverage and definition of the decoder lines it is important that the distance between consecutive single pixel lines has a maximum value of 1 pixel. As G>H we can set this step distance as:

S=H/G

The decoder screen can then be produced by stepping through values of X1, advancing by steps of S. Conventional programming tactics are used to avoid summation errors when implemented in practical software. For each value of X1 the corresponding values of Y1, X2, Y2 are determined or calculated and the corresponding single pixel line is drawn or skipped as required to produce the decoder black and white lines. When these decoder screens are used to generate the hidden image, the same separation (line width) is found in features of the hidden image.

This embodiment addresses a problem with Hidden Images in that they are hard to see, and certainly not eye-catching, when revealed with a conventional decoding screen. They are completely covert devices. These types of devices, and in particular those with colour introduced through the hiding or revelation of the sub-pixel, are covert until held near an appropriate display monitor, at which point they become extremely overt, highly visible devices.

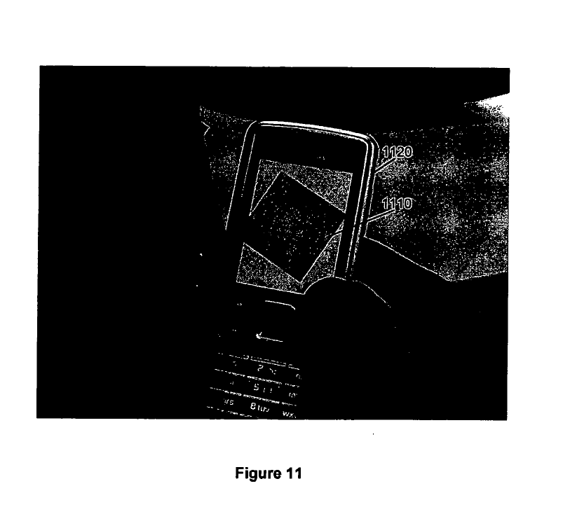

As indicated above, a number of effects can be achieved including encoding plural images within a single hidden image which can be decoded at different angles relative to the display, or providing an image portions of which will decode on monitors of different resolution or providing a series of images tuned to different resolutions. The images can be decoded on any display, such as computer monitors, televisions, point of sale displays, dedicated monitors, mobile phone monitors or mp3 player displays. FIG. 11 shows an image 1110 decoded on a mobile phone display 1120.

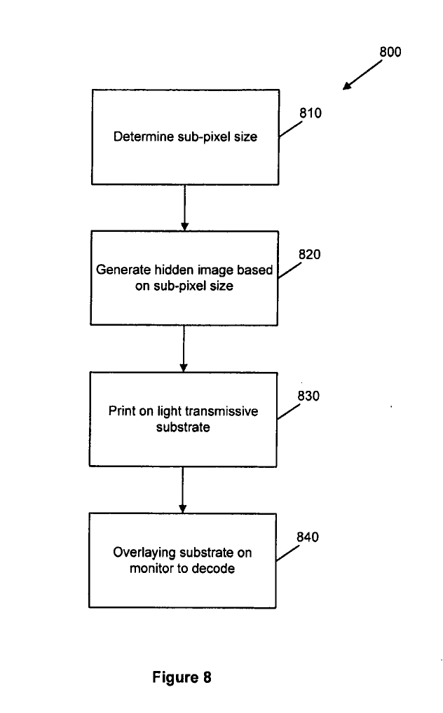

The method 800 of this embodiment is summarized in FIG. 8 and involves determining 810 the pixel size of the intended display, generating 820 a hidden image based on the sub-pixel size, printing 830 the hidden image to form a light transmissive substrate with the image thereon, and overlaying 840 the substrate on a monitor to decode the hidden image.

### Encoding Colour to be Decoded by Sub-Pixels

In this example a printed monochrome, black and white (clear) image on transparent media can conceal an image which will render a true colour image when sub-pixel decoded in the manner described above by a monitor having sub-pixels. The colour information is independently encoded into the full sized pixels that define the printed colour encoding image; effectively the shape and position is changed at the sub-pixel level to provide the correct colour and colour intensity. Because of this independence, and provided that sufficient full size carrier pixels exist in the black and white image, additional or completely different information can be encoded in the colour channel image. So simple hidden images (e.g. short bold text messages) can be concealed in the black and white image and revealed when decoded on a monitor. There will always be a predominance of the printed black and white image so the decoded information will appear as a lighter overprint. That is, the image can encode a colour version of the black and white image or another element such as a word.

The other import factor about sub-pixel screens is the increase in resolution. Working at sub-pixel level provides a resolution boost of 3 times in the horizontal direction over the normal resolution ascribed to the monitor. In addition the technique that is used to provide the variation in colour intensity as described below is not limited by monitor resolution but by the resolution of the technology used to produce the printed image which currently is typically twenty times greater than the monitor resolution. The increased resolution provides greater security because of the increased difficulty of copying.

A typical monitor display is composed of vertical RGB stripes of discrete sub-pixels. The order (RGB) of these stripes is usually the same from monitor to monitor. Usually the sub-pixels are very close together so when magnified, while active, they appear continuous in the vertical direction and only appear segregated along the horizontal because of the different colours. Some displays also have vacant zones (black) horizontal stripes running across the monitor in a regular pattern. These black lines have some effect but are not totally detrimental. For this discussion it is assumed that the monitor display is composed of apparently continuous vertical RGB stripes.

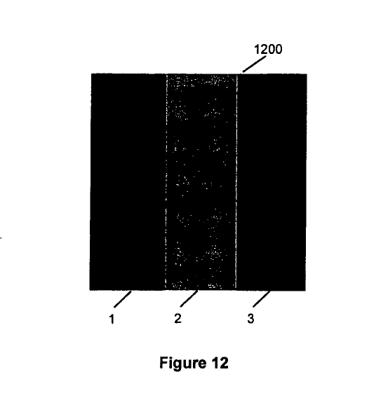

FIG. 12 shows one section 1200 of the display corresponding to a pixel has a red stripe 1, a green stripe 2 and a blue stripe 3.

The section 1200 of FIG. 12 would normally represent white on the monitor display because all three sub-pixels 1,2,3 are fully active. Normally to preserve a 1:1 aspect ratio the width and height of the pixel are exactly the same to avoid distortion of displayed images. For the current discussion the vertical resolution and construction of the monitor is totally irrelevant; everything will average out and many of the examples below would work equally well if extended to several vertical monitor pixels or contracted to fractions of vertical monitor pixels.

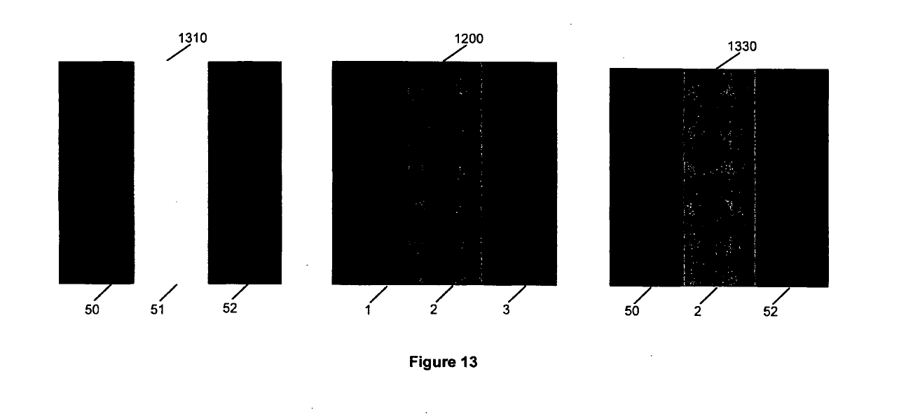

In the simplest case one can produce coloured pixels by the printed design selectively obscuring the un-needed sub-pixels. For example, as shown in FIG. 13, screen 1310 composed of black 50,52 and clear 51 stripes covering section 1200 produces section 1330 composed of black stripes 50,52 and green sub-pixel 2 thus displaying green.

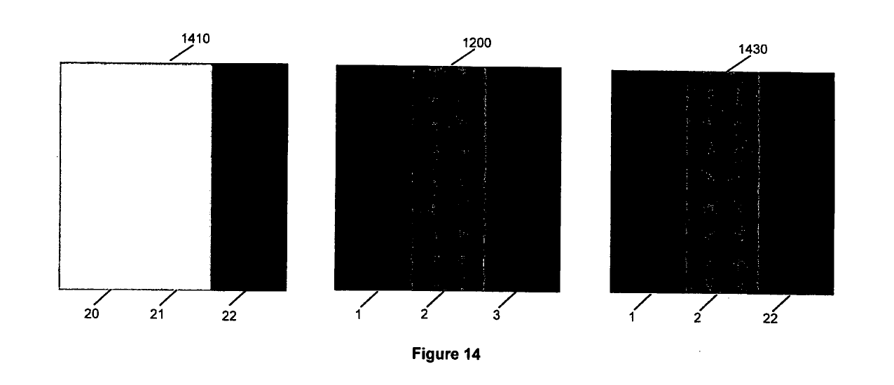

Similarly, as shown in FIG. 14, screen 1410 composed of black 22 and clear 20,21 stripes covering section 1200 produces section 1330 composed of black stripe 22, red sub-pixel 1 and green sub-pixel 2 thus displaying yellow.

Other colours can be achieved by covering appropriate sub-pixels, for example with all three sub-pixel covered black is perceived.

Notice that if the screen is displaced within the same full pixel it will still look the same in the undecoded black and white dithered image but the colour produced will be different. This means a separate coloured latent image can be hidden in the black and white image and to be decoded on the monitor.

In the above example each colour's intensity has only two levels; full on or fully off (black). The ability to print at much higher resolution than even the sub-pixel size of the monitor provides the ability to individually control each colour's intensity. With current typical technologies potentially ˜300 levels of intensity could be obtained. Moreover the use of high resolution printing provides a means to include additional channels of encoding.

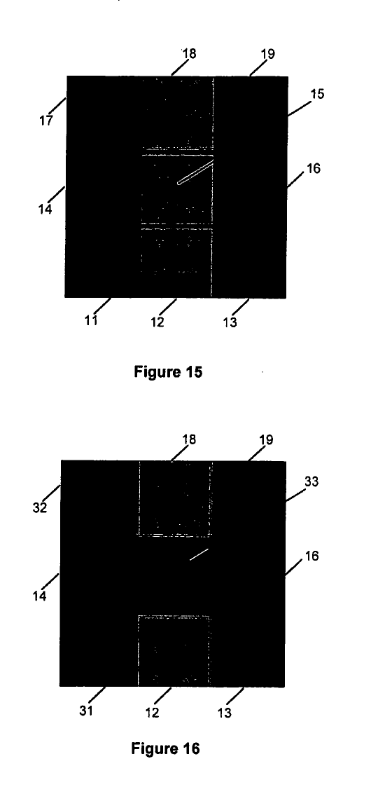

For example, as illustrated in FIG. 15 taking advantage of the higher resolution of printing and promote the each display pixel to a notional array 1510 of 3×3 sub-pixel components 11-19—i.e. three components 11,14,17 for red, three components 12,15,18 for green and three components 13,16,19 for blue.

It is thus possible to provide 4 intensity levels for each individual colour by uncovering 0, 1, 2 or 3 sub-pixels of that colour.

For example, as shown in FIG. 16, covering selected components 11,15,17 with screen components 31,32,33 results in a sky blue pixel by combining 1/9 red, 2/9 green and 3/9 (1/3) blue.

Notice that the printed design has 3 black sub-pixels; if any 3 of the 9 sub-pixels are black in the printed design the dither of the black and white image will appear the same before decoding.

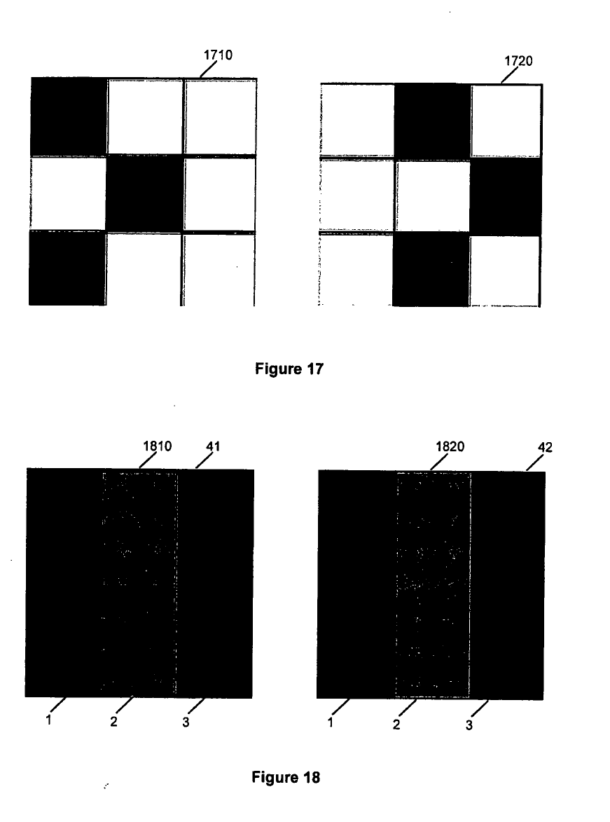

That is the screen 1710 and 1720 of FIG. 17 will produce the same average level grey in that local area in the black and white printed image, but the decoded colour would be different.

Notice that any of the 9×8×7=504 positions for the 3 black pixels will produce exactly the same average level grey in that local area in the black and white printed image but of these only those that have 2 blacks in the red column and 1 in the green 3×3×1=9 will produce the original intended sky blue.

Similar calculations can be performed for any of the 10 possible local average grey levels possible wherein 0 to 9 sub-pixels are black. There are a maximum of combinations when about half the possible sub-pixels are black.

The fact that there exist a set of combinations that produce the same visual result both in the printed black and white image and the decoded image provide yet another potential level for encoding of information. For example two similar devices that provide exactly the same results when viewed or decoded on a monitor could reveal yet another hidden image when the two devices were superimposed.

The above example employs a 3×3 array but with current technology it is possible to print at about 30 times the resolution of a typical monitor. This means that every monitor pixel could be divided up into ˜900 notional sub-pixels so that each monitor sub-pixel could have around 300 printals available for control of the colour intensity. This provides added security particularly if the images used for this device make use of the full shade range so that poor quality copies are clearly differentiated when decoded. The higher resolution provides for the concealment of higher levels of additional information as discussed above.

Another example of where high resolution could be used is to hide phase coded information.

The examples shown above effectively control colour by horizontal modulation and intensity by vertical modulation. It is also possible to control both in the horizontal. An example, is shown in FIG. 18, wherein in a first image 1810, a black stripe 41 covers the left half of the blue sub-pixel 3 and in the second image 1820, a black stripe 42 covers the right half of the blue sub-pixel 3.

This will produce exactly the same colour when perfectly aligned on the monitor and look exactly the same in the printed dithered black and white picture. But when the image is moved slightly off alignment they will appear different. In this example when the first black and white frame is moved ½ a sub-pixel to the right it will look exactly the same (look like the right hand image) but the second black and white frame when moved % a sub-pixel to the right will now be covering half of the neighbouring red pixel an look different. By this means it is possible encode phase encoded images that flash in and out of view as you slide the printed device across the monitor.

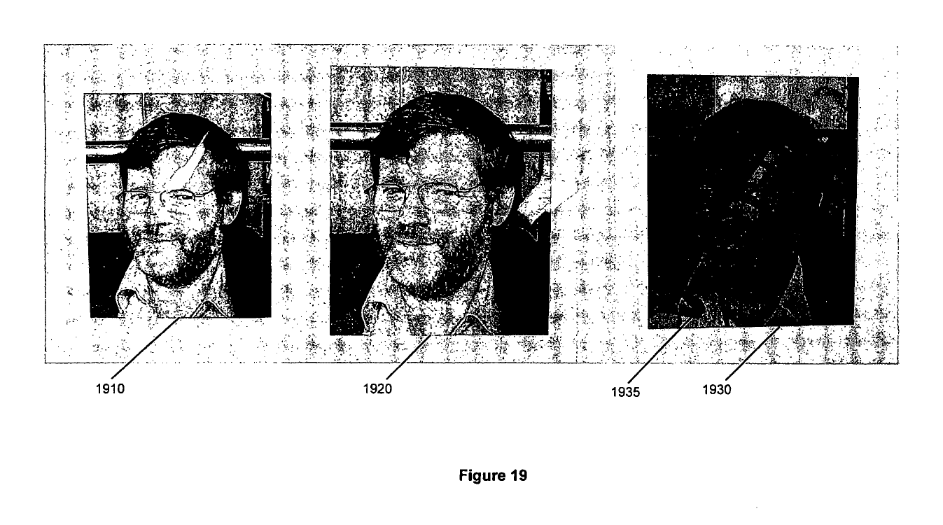

FIG. 19 shows examples of the above technique. Image 1910 corresponds to a black a white image printed on a transparent substrate within which colour information is encoded. Image 1920, shows the image decoded to reveal a colour image of the same photo (visible within the black and white reproduction of image 1920 as an increased number of shades). Image 1930, shows a decoded image where the word “verified” 1935 has been encoded.

Accordingly, this aspect can be advantageously employed to form hidden image substrates comprising a light transmissive substrate having printed thereon a hidden image based on a sub-pixel size of the display which is intended to be used to decode the hidden image. Such hidden image substrates can form part of an article such as a bank note or be attached to an article such that the article can subsequently be authenticated.

### Distribution and Generation of Decoders

In embodiments where decoders need to be distributed, an advantage of the decoders being electronic is that they can be distributed over a communication network and/or stored in digital form. For example, a library of decoders could be stored in local database or a central database accessed via a communication network.

Similarly, a database of scaling factors for different display monitors based on manufacturer and model could be built and maintained, obviating the need for user calibration. The database could be self building in conjunction with a network and user calibration factor returns; this would require the user entering his display monitor device details during calibration.

In addition to the above, where the display is incorporated (or associated with) a display device having sufficient processing power, the decoder can be generated at the device by executing program code which implements the relevant algorithm.

### Exemplary Apparatus

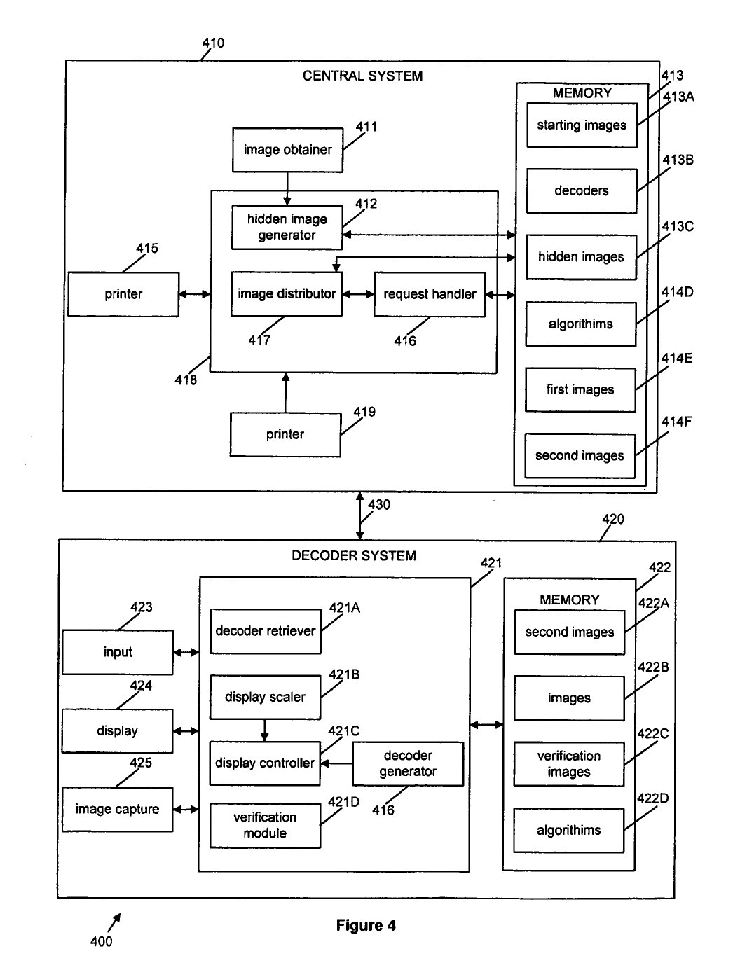

FIG. 4 shows an exemplary apparatus 400. In this example, a large number of functions are implemented by the central system 410 and the decoder system 420. A person skilled in the art will appreciate that various different combinations of these functions can be implemented depending on the embodiment and that they are shown together in FIG. 4 for the purpose of exemplification.

The central system 410 contains the components for generating hidden images and distributing them to a decoder system as well as printing them. A person skilled in the art will appreciate that in some embodiments an embossing process will work as effectively as a printing process.

The hidden image generator 412 obtains a source image either from an image obtainer 411 in the form of a camera or the like or from starting images 413a stored in memory 413. The hidden image generator generates a hidden image 413c employing decoder 413b and an algorithm 414d stored in memory. Once generated the hidden image is stored in the memory 413 as hidden image data 413C. The hidden image generator 412 and other functions of the central system are implemented by a processor executing program code stored in memory. In the case of the hidden image generator 412 the program code implements the relevant algorithm(s) for encoding the images and a user can make selections (as necessary) using an input device 419 such as a mouse, keyboard etc. Other elements typically found in a computing system can also form part of the apparatus 400.

The hidden image generator 412 may also perform some of the functions described above, for example to swap portions of the decoder and the hidden image to thereby produce first and second images 414E and 414F—i.e. a pair of images which provide between them (either separately or in combination) the decoder and the hidden image. The hidden image generator 412 causes the first image to be printed by printer 415 on a suitable substrate such as a transparent film.

One exemplary function shown in FIG. 4 is an image distributor 417 which sends the relevant second images to the decoder system 420 over network 430. In an alternative embodiment, the second decoder is delivered in response to a request received from the decoder system 420. Central system includes a request handler 416 for receiving a request and determining which decoder is to be delivered before they are distributed by image distributor 417.

Turning to the decoder system 420 it includes an input device 413 which allows a user to provide calibration information to a display scaler 421B which controls the display controller 421C to display the decoder at the right resolution on display 414. The decoder being stored as second images data 422A in the memory 422. That is, in one embodiment, the display controller 421C simply retrieves either the current or an appropriate one of the second images 422A from memory 422. In an alternative embodiment the decoder system 420 employs a decoder generator 421E to generate an appropriate decoder using algorithm 422D. In the example shown in FIG. 4, the various functions 421A to 422E are shown as being software modules implemented by a processor 421 executing program code stored in memory 422. A person skilled in the art will appreciate that these functions can also be implemented using dedicated circuits.

Once an operator wishes to have the display show the second image and the display has been calibrated, the operator operates input device 423 to generate an appropriate command such that the display controller 421c will display on display 424 the appropriate second image so that the first image can be overlayed.

The embodiment shown in FIG. 4 incorporates two additional functions. In one embodiment, the decoders can be retrieved on demand by providing a decoder identification in association with the first image, for example by printing it on the transparent substrate, or providing it elsewhere with the document and/or instrument of which the first image forms a part. The operator enters the decoder identification and decoder retriever 421A retrieves the relevant decoder; in one embodiment from the second image database 422A and in another embodiment over the network 430 by sending a request to central system 410. In this later embodiment, when the request is received the request handler 416 uses the decoder identification to retrieve second image 414F from memory 413 and transmit it via image distributor 417 to the decoder system 430. Display controller 421C is configured to display 424 the relevant decoder once it is received. In another embodiment, the request handler 416 and/or the image distributor may apply additional rules stored in memory 413 to control when decoders are released, for example such that a decoder is only available after a specific date or during a specific time window to thereby reduce the prospect of the decoder being obtained by a malicious party. For example, tickets to a large event such as the Olympics could be produced and distributed months in advance but the decoder or decoders release could be controlled unit just before the event. Similar functionality can be embedded within decoder generator 416.

A further function provided in this exemplary apparatus, is an automatic verification function. That is, rather than a person checking the images, they can be checked automatically. To this end an image capture device 425 is provided at a position such that it can view the superposed image. One or more images are captured and provided to a verification module 421D which stores the captured images 422B. These can be compared locally to verification images 423C corresponding to the image that should be decoded by the relevant decoder. In other embodiments the verification module could be implemented in part at the central system and the verification image stored centrally—i.e. the captured image could be sent to the central system 410 for verification.

It will be appreciated that in the sub-pixel decoder embodiment described above not all of these components are required to implement the embodiment.

Persons skilled in the art will appreciate that the central system, and more typically, the decoder system (or at least the key decoding functions thereof) could be provided by supplying and installing program code on a suitable computing device with a display. The program code could be supplied in a number of ways, for example on a tangible computer readable medium, such as a disc or a memory (for example, that could replace part of memory 103) or as a data signal (for example, by transmitting it from a server) such that it can be installed and stored in a tangible memory of the computing device.

### Additional Components

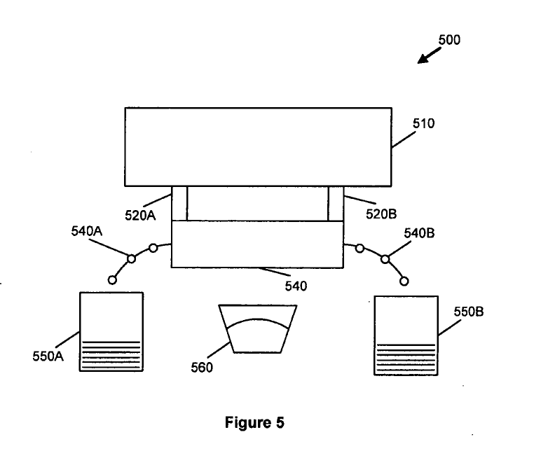

FIG. 5 illustrates schematically some components which could be employed in conjunction with this method. In the schematic exemplary apparatus arrangement 500 an image holder 430 is provided at a relevant place relative to the display. As illustrated in FIG. 5, this holder 530 can be spaced by spacers 520A, 520B from the display surface 510. Conveying mechanisms can be provided 540A, 540B to feed elements having the image thereon from a first feed bin 550a to a second feed bin 550b such that they are passed through the holder 530 mechanically. A camera 560 can be placed at an appropriate location to capture images to be verified in the manner described above in relation to FIG. 4.

Persons skilled in the art will appreciate that various elements of FIG. 5 can be deployed independently of one another in particular the decision whether use of spacers 520A depends on the application. In some embodiments it would be desirable to have spacers so that the exact spacing of the image from the display is only known to people having access to the apparatus 500. A holder of appropriate dimensions 530 can be used to hold the image at the correct superposition relative to display 50. Conveying mechanism 540 and feed bins 550 are appropriate in circumstances where it is necessary to process a large number of images.

### Applications

The methods of embodiments of the invention can be used to produce security devices which incorporate a hidden image to thereby increase security in anti-counterfeiting capabilities of items such as tickets, passports, licences, currency, and postal media. Other useful applications may include credit cards, photo identification cards, tickets, negotiable instruments, bank cheques, traveller's cheques, labels for clothing, drugs, alcohol, video tapes or the like, birth certificates, vehicle registration cards, land deed titles and visas.

Typically, the security device will be provided by embedding the image containing the hidden image within one of the foregoing documents or instruments.

### Advantages

An advantage of embodiments of the invention is that it eliminates the need for separate manufacture of decoders as the decoder or program code embodying the decoder algorithm can be sent to the end users electronically.

Another advantage is that the circulated decoder can be replaced rapidly in the case of a security breach.

### Variations

It will be understood to persons skilled in the art that many modifications may be made to the above embodiments, in particular features of various embodiments and examples may be combined to form further embodiments.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that any reference to prior art herein does not constitute an admission that the prior art forms a part of the common general knowledge in the art in any country.

1. A hidden image method comprising:
obtaining a first image and a second image, the first and second images providing between them a hidden image and a decoder such that a hidden image is decoded by the decoder when the first image and the second image are superposed at least one decoding position;
printing the first image onto a light transmissive substrate to produce a printed substrate;
displaying the second image on an electronic display; and
superposing the printed substrate relative to the display at a decoding position to decode the hidden image.

2. A method as claimed in claim 1, wherein the decoder comprises a plurality of decoder lines.

3. A method as claimed in claim 2, comprising configuring at least one of the first and second images such that the decoder lines are offset from the horizontal and vertical axes of the display to avoid visible moirés.

4. A method as claimed in claim 1, further comprising scaling the display of the second image based on a display format of the electronic display.

5. A method as claimed in, wherein the decoder is provided by one of the first and second images.

6. A method as claimed in claim 5, wherein the decoder is provided by the second image.

7. A method as claimed in claim 1, wherein the decoder is provided by both of the first and second images.

8. A method as claimed in claim 1, wherein each of the first and second images comprises a plurality of image elements arranged to form the hidden image and the decoder.

9. A method as claimed in claim 6 comprising storing data representing the second image in a memory associated with the display.

10. A method as claimed in claim 9, comprising generating the data representing the second image at a location remote from the memory and transmitting the data to the memory.

11. A method as claimed in claimed in claim 10, comprising transmitting the data in response to a request from a processor operably associated with the memory.

12. A method as claimed in claim 11, comprising providing a decoder identification with the printed substrate, receiving an input of the decoder identification via an input device associated with the processor and making the request in response to receipt of the decoder identification.

13. A method as claimed in claim 9, comprising generating the data representing the second image with a processor associated with the memory based on at least one decoder algorithm.

14. A method as claimed in claim 13, comprising providing a decoder identification with the printed substrate, receiving an input of the decoder identification via an input device associated with the processor and generating the second image with the processor based on the decoder identification.

15. A method as claimed in claim 10, comprising controlling a time at which the decoder is transmitted.

16. A method as claimed in claim 13, comprising controlling a time at which the decoder is generated.

17. A method as claimed in claim 1 comprising spacing the first image from the surface of the display.

18. A method as claimed in claim 1, wherein the first and second images encode at least one additional hidden image.

19. A method as claimed in claim 18, wherein the first image encodes the at least one additional hidden image.

20. A method as claimed in claim 19, comprising altering the display of the second image to decode the at least one additional hidden image.

21. A method as claimed in claim 20 comprising moving the second image on the display.

22. A method as claimed in claim 20 comprising replacing the display with a display of at least one further image which provides a decoder for the additional image.

23. A method as claimed in claim 1, comprising selectively decoding portions of the first image by altering display of the second image.

24. A method as claimed in claim 1, comprising sequentially decoding portions of the first image by altering display of the second image.

25. A method as claimed in claim 1 comprising printing on the light transmissive substrate with an opaque ink.

26. A method as claimed in claim 25, wherein the ink is black.

27. A method as claimed in claim 25, wherein the ink is white or silver.

28. A method as claimed in claim 1 comprising obtaining the hidden image and the decoder by generating them using a computerised security algorithm.

29. A hidden image method comprising:
obtaining a set of images, providing between them a plurality of hidden images and a plurality of decoders such that each hidden image is decoded by a corresponding decoder when at least two of the images are superposed at least one decoding position;
printing at least one of the images onto a light transmissive substrate;
displaying at least one of the images on an electronic display; and
superposing the printed substrate relative to the display at a decoding position to decode the hidden image corresponding to the decoding position.

30. A hidden image apparatus comprising:
a printed substrate comprising a first image printed on a light transmissive substrate, the first image in conjunction with a second image providing a hidden image and a decoder such that a hidden image is decoded by the decoder when the first image and the second image are superposed at least one decoding position; and
a display device comprising an electronic display arranged to display the second image such that the printed substrate can be superposed relative to the display at a decoding position to decode the hidden image.

31. A hidden image apparatus as claimed in claim 30, wherein the display device is arranged to scale the display of the second image based on a display format of the electronic display.

32. A hidden image apparatus as claimed in claim 30, wherein the display device comprises an input device for receiving a user input, the display device configured to scale the display of the second image in response to the user input.

33. A hidden image apparatus as claimed in claim 30, wherein the display device comprises a memory storing data representing the second image.

34. A hidden image apparatus as claimed in claim 32, wherein the display device is arranged to receive data representing the second image transmitted from a location remote from the memory and store the data in the memory.

35. A hidden image apparatus as claimed in claim 33, wherein the display device is arranged to transmit a request for data representing the second image.

36. A hidden image apparatus as claimed in claim 35, wherein the display device comprises an input device and is arranged to receive an input of a decoder identification via the input device and make a request including the decoder identification in response to receipt of the decoder identification.

37. A hidden image apparatus as claimed in claim 31, wherein the display device comprises a processor and a memory storing at least one decoder algorithm, the processor arranged to generate the second image based on the at least one decoder algorithm.

38. A hidden image apparatus as claimed in claim 37, wherein the processor generates the second image in response to receipt of a decoder identification via the input device and uses the decoder identification to generate the second image.

39. A hidden image apparatus as claimed in claim 37, wherein the display device is arranged to control a time at which the second image is generated.

40. A hidden image apparatus as claimed in claim 29, wherein the display has a fixed number of pixels.

41. A hidden image apparatus as claimed in any one of claim 29, further comprising a spacer for spacing the first image from the surface of the display.

42. A hidden image apparatus as claimed in claim 29, further comprising a printed substrate holder for holding the printed substrate at a decoding position relative to the display.

43. A hidden image apparatus as claimed in claim 42, further comprising a feeding mechanism for feeding printed substrates to the printed substrate holder.

44. A hidden image apparatus as claimed in claim 42, further comprising a removal mechanism for removing printed substrates from the printed substrate holder.

45. A hidden image apparatus as claimed in claim 29 comprising an verification image capture device arranged to capture a verification image of the light transmissive substrate superposed on the display.

46. A hidden image apparatus as claimed in claim 45, comprising a verification module arranged to determine from the verification image whether the hidden image has been decoded.

47. A hidden image apparatus as claimed in claim 29 wherein at least a third image in combination with the first and second images provides a further hidden image which can be decoded by the decoder or a further decoder.

48. A hidden image apparatus as claimed in claim 47 comprising a further printed substrate carrying the third image.

49. A display device for a hidden image apparatus comprising:
a memory storing data representing a second image of a first image and a second image, the first and second images providing between them a hidden image and a decoder such that a hidden image is decoded by the decoder when the first image and the second image are superposed at least one decoding position; and
an electronic display arranged to display the second image such that the first image can be superposed relative to the display at a decoding position to decode the hidden image.

50. (canceled)

51. A tangible computer readable medium comprising the computer program code which when executed implements the method of claim 1.

52. A hidden image method comprising:
generating an image containing a hidden image based on a pixel size of at least one display intended to be used to decode the image;
printing the image on a light transmissive substrate to form an image substrate; and
overlaying the image substrate on a display compatible with the intended display so that the image substrate is decoded by the sub-pixels of the display to reveal the hidden image.

53. A method as claimed in claim 52, wherein generating an image based on a pixel size comprises setting the size of features encoding the hidden image based on the pixel size.

54. A method as claimed in claim 53 comprising setting the separation of periodic elements in the hidden image to correspond to the pixel size.

55. A method as claimed in claim 52, comprising encoding the hidden image as a Phasegram.

56. A method as claimed in claim 52, wherein the image encodes two different hidden images, viewable at different angles of the substrate relative to the display.

57. A method as claimed in claim 52, comprising generating a first portion of the image based on the pixel size of a first display intended to be used to decode the first portion and generating a second portion of the image based on the pixel size of a second display intended to be used to decode the second portion.

58. A method as claimed in claim 52, wherein the pixel size of the intended display is derived from the actual pixel size of a plurality of displays.

59. A method as claimed in claim 52, comprising printing the image in monochrome at least portions of the image to encode colour and intensity of colour.

60. A method as claimed in claim 59, comprising dividing the hidden image into notional vertical pixel regions intended to overlay a colour of a one or more contiguous sub-pixels of the intended display and selectively controlling which portions of the notional sub-pixel are opaque to control the intensity of the colour.

61. A method as claimed in claim 59, comprising printing opaque regions less than the width of a sub-pixel to control the intensity of a sub-pixel.

62. A method as claimed in claim 59 comprising printing the image in black and white.

63. A hidden image substrate comprising a light transmissive substrate having printed thereon a hidden image based on a sub-pixel size of a display intended to be used to decode the hidden image.
